(19) United States
(12) Patent Application Publication
(10) Pub. No.: US 2015/0277723 A1
(43) Pub. Date: Oct. 1, 2015

(54) EXPORTING A COMPONENT OF A CURRENTLY DISPLAYED USER INTERFACE TO A DEVELOPMENT SYSTEM

(71) Applicant: NIIT Technolgies Ltd, New Delhi (IN)

(72) Inventors: UDAYAN BANERJEE, Bangalore (IN); Radha Tupil, Bangalore (IN); Vikram Nagaraja Rao, Bangalore (IN); Kanakalata Narayanan, Bangalore (IN); Deepesh P. C., Bangalore (IN); Mahadevan P., Bangalore (IN)

(21) Appl. No.: 14/462,599

(22) Filed: Aug. 19, 2014

(30) Foreign Application Priority Data
Mar. 31, 2014 (IN) 1716/CHE/2014

(51) Int. Cl. G06F 3/0484

(52) U.S. Cl. CPC G06F 3/04847; G06F 3/04842

(57) ABSTRACT

According to an aspect of the present disclosure, a repository of (user interface) components is maintained, with each component having an associated interface definition. A user interface containing a set of components rendered on a display unit is then provided, the set of components being contained in the repository. In response to receiving from a user, a selection of a component rendered on the display unit, the interface definition of the selected component is made available in defining a new user interface in a development system.

### PRIORITY CLAIM

The instant patent application is related to and claims priority from the co-pending provisional India patent application entitled, “Exporting A Component Of A Currently Displayed User Interface To A Development System”, Serial No.: 1716/CHE/2014, Filed: 31 Mar. 2014, which is incorporated in its entirety herewith.

### BACKGROUND OF THE DISCLOSURE

1. Technical Field

The present disclosure relates to software systems, and more specifically to exporting a component of a currently displayed user interface to a development system.

2. Related Art

A user interface refers to the manner in which a user is enabled to interact with an application. Such interaction typically entails receiving inputs from the user and rendering (displaying, playing sounds, etc.) the outputs generated in an end user/live system, typically by processing of the inputs. User interfaces are often used in applications to simplify receiving appropriate inputs (e.g., by various textual/graphical user interface elements) and also providing outputs in a visually/audibly presentable manner.

A user interface normally contains multiple user interface components (hereafter referred to as just “components”). Each component typically controls the interaction of the user in a corresponding bounded portion of the displayed area on a physical display (e.g., a display screen). Each component is embodied in the form of attributes and/or code (“interface definition”), which together define the user interaction when the component is displayed on the physical display of the end user system.

Development systems, in contrast to end user systems, are used for designing/development of user interfaces. The end product of a typical development effort is to define the components of a user interface, which can thereafter be easily rendered on an end user system. In a typical development cycle, a developer may determine the specific location and other attributes of the individual components together forming the user interface sought to be developed.

While interacting with user interfaces, a developer may wish to incorporate some suitable components of a currently displayed user interface (in a end user system) into a new user interface sought to be developed in a development system. Accordingly, it may be desirable to export such suitable components of a currently displayed user interface to a development system.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which exporting a component of a currently displayed user interface to a development system is facilitated according to an aspect of the present disclosure.

FIG. 3 depicts the manner in a user/developer is enabled select a desired component of a currently displayed user interface in one embodiment.

FIG. 4A illustrates the manner in which an application development environment (ADE) is provided in a development system in one embodiment.

FIG. 4B illustrates the manner in which a component of a currently displayed user interface is provided as part of an application development environment (of FIG. 4A) in one embodiment.

FIG. 5 illustrates the manner in which exporting of components of a currently displayed user interface to a development system is implemented in one embodiment.

FIG. 6A illustrates the manner in which interface definitions of components are maintained in a repository in one embodiment.

FIG. 6B illustrates an example implementation of a repository browser.

FIG. 7 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

According to an aspect of the present disclosure, a repository of (user interface) components is maintained, with each component having an associated interface definition. A user interface containing a set of components rendered on a display unit is then provided, the set of components being contained in the repository. In response to receiving from a user, a selection of a component rendered on the display unit, the interface definition of the selected component is made available in defining a new user interface in a development system.

According to another aspect, each component in the repository is assigned a corresponding identifier, and accordingly the identifiers of the set of components are embedded in a specification of the user interface (noted above). The specification is then sent to an end user system containing the display unit (noted above), wherein the end user system renders the specification to provide the user interface on the display unit. As such, in response to a user selecting a component, the identifier of the selected component is first identified by examining the specification of the user interface, and then using the identified identifier, the interface definition of the selected component is transferred from the repository to the development system.

In an embodiment of the present disclosure, the transferring of the interface definition noted above is performed manually by a user. The identifier identified in response to the selection of a component is exposed (e.g., displayed, sent by email, etc.) to the user. Accordingly, the user is enabled to download, using the exposed identifier, the interface definition of the selected component from the repository to the development system.

According to one more aspect of the present disclosure, when the new user interface is being developed using a application development environment (ADE) in the development system, in response to a user selecting a component, the selected component is made available as part of the ADE in the development system such that the user is enabled to incorporate the selected component into new user interfaces.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

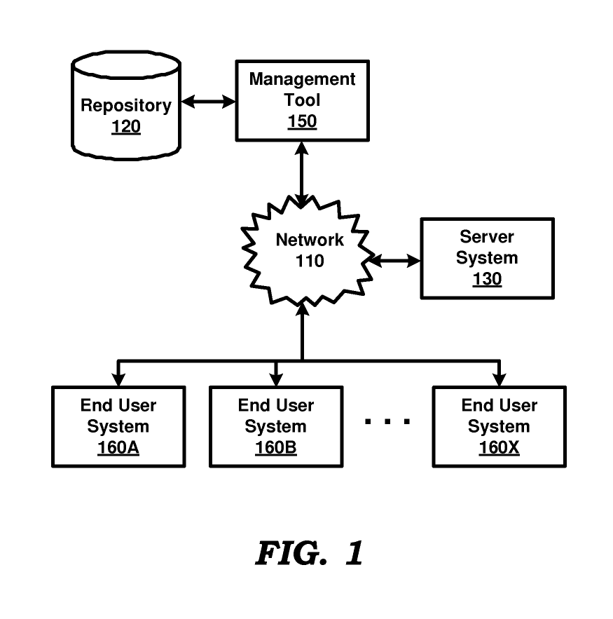

FIG. 1 is a block diagram illustrating an example environment (computing system) in which several aspects of the present invention can be implemented. The block diagram is shown containing network 110, repository 120, server system 130, management tool 150, and end user systems 160A-160X.

Merely for illustration, only representative number/type of systems is shown in FIG. 1. Many environments often contain many more systems, both in number and type, depending on the purpose for which the environment is designed. Each block of FIG. 1 is described below in further detail.

Network 110 provides connectivity between server system 130, management tool 150 and end user systems 160A-160X, and may be implemented using protocols such as Transmission Control Protocol (TCP) and/or Internet Protocol (IP), well known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by network 110.

Repository 120 represents a non-volatile (persistent) storage facilitating storage and retrieval of a collection of data (such as the interface definitions of various components, identifiers assigned to each component, etc.) by management tool 150. Repository 120 may be implemented as a database server using relational database technologies and accordingly provide storage and retrieval of data using structured queries such as SQL (Structured Query Language). Alternatively, repository 120 may be implemented as a file server providing storage and retrieval of data in the form of files organized as one or more directories, as is well known in the relevant arts.

Server system 130 represents a server, such as a web/application server, executing applications capable of performing tasks requested by users using one of end user systems 160A-160X. A server system may use data stored internally (for example, in a non-volatile storage/hard disk within the server system), external data and/or data received from external sources (e.g., from the user) in performing such tasks. The server system then sends the result of performance of the tasks to the requesting end user system (one of 160A-160X). The results may be accompanied by specific user interfaces (e.g., web pages) for displaying the results to the requesting user.

Each of end user systems 160A-160X represents a system such as a personal computer, workstation, mobile station, mobile phones, computing tablets, etc., used by users to generate requests directed to applications executing in server system 130. The requests may be generated using appropriate user interfaces (e.g., web pages provided by an application executing in a server system, a native user interface provided by a portion of the application downloaded from the server system, etc.). In general, an end user system requests an application for performing desired tasks and receives corresponding responses containing the results of performance of the requested tasks.

It may be appreciated that at least some of end user systems 160A-160X can be development systems used by users/developers to create (and/or modify) applications executing in server system 130. In particular in a development system, developers of an application specify software instructions designed to provide a corresponding user interface and perform specific tasks request by the user using the provided user interface. As is well known, the software instructions are commonly specified using a high-level programming language such as C, C++, Java, C#, etc., with the specified instructions then converted/compiled into executable code (e.g., binary code executed by a processor, intermediate code executed by a virtual machine, etc.) before being deployed on one or more of server system 130.

One challenge to creation of a new application (or a modification of an existing application) is the development of the user interfaces of the application. As noted in the Background section, a user/developer may wish to incorporate some suitable components of a currently displayed user interface (provided by applications executing in server system 130) into a new user interface sought to be developed (in the development system).

Management tool 150, provided according to several aspects of the present invention, facilitates a user/developer to export suitable components of a currently displayed user interface (on a end user system) to a development system, as described below with examples.

### 3. Exporting Component of a Currently Displayed User Interface

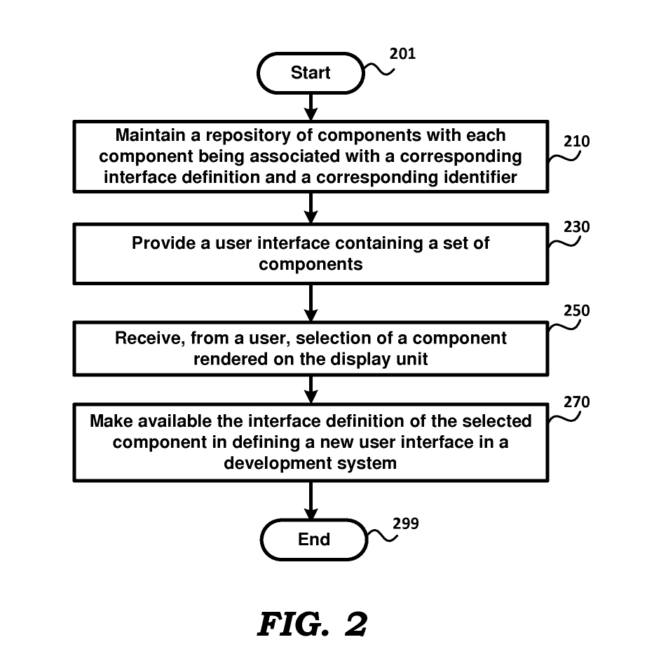

FIG. 2 is a flow chart illustrating the manner in which exporting a component of a currently displayed user interface to a development system is facilitated according to an aspect of the present invention. The flowchart is described with respect to FIG. 1 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, management tool 150 maintains a repository (120) of components, with each component having a corresponding identifier and being embodied as a corresponding interface definition. The interface definition of a component specifies the details of presentation (such as the color, font, width, height, etc.) of the component, and also the behavior of the component. Behavior encompasses aspects such as the actions that may be performed with respect to the component and the events to which the component is designed to respond. The interface definitions may be stored in repository 120, for example, in the form of corresponding files.

In step 230, a user interface, containing a set of components, is provided on a display unit. Providing the user interface entails rendering the set of components on the display unit. The set of components (or the corresponding interface definition) may be contained in the repository. In one embodiment, the corresponding identifiers of the set of components are embedded in a specification of the user interface, and the specification is then sent to an end user system (160A) containing the display unit, wherein end user system 160A renders the components according to the specification to provide the user interface on the display unit.

In step 250, management tool 150 receives, from a user, (data/signal representing) selection of a component rendered on the display unit. The selection may be received from the user/developer in a known way, for example, using input devices such as mouse and keyboard to point out the specific component sought to be exported to a new user interface.

In step 270, management tool 150 makes available the interface definition of the selected component in defining a new user interface in a development system (assumed to be end user system 160A, though in alternative embodiments the development system may be any one of end user systems 160A-160X). In one embodiment, management tool 150 first identifies the identifier of the selected component by examining the specification (containing the embedded identifier) and then automatically (i.e., without further manual intervention) transfers using the identifier, the interface definition of the selected component from the repository to the development system.

Alternatively, management tool 150 after identifying the identifier, exposes (displays, sends by email, etc.) the determined identifier to the user, thereby enabling the user to download using the exposed identifier, the interface definition of the selected component from the repository to the development system.

In another embodiment, when the new user interface is being developed using a application development environment (ADE) in the development system, management tool 150 provides the selected component as part of the ADE in the development system such that the user is enabled to incorporate the selected component into the new user interface. The flow chart ends in step 299.

Thus, a user/developer is facilitated to identify the specific components of interest in the user interfaces of existing applications and thereafter incorporate the components of interest in a new user interface being developed. The manner in which management tool 150 facilitates exporting of components according to the flow chart of FIG. 2 is described below with examples.

### 4. Illustrative Example

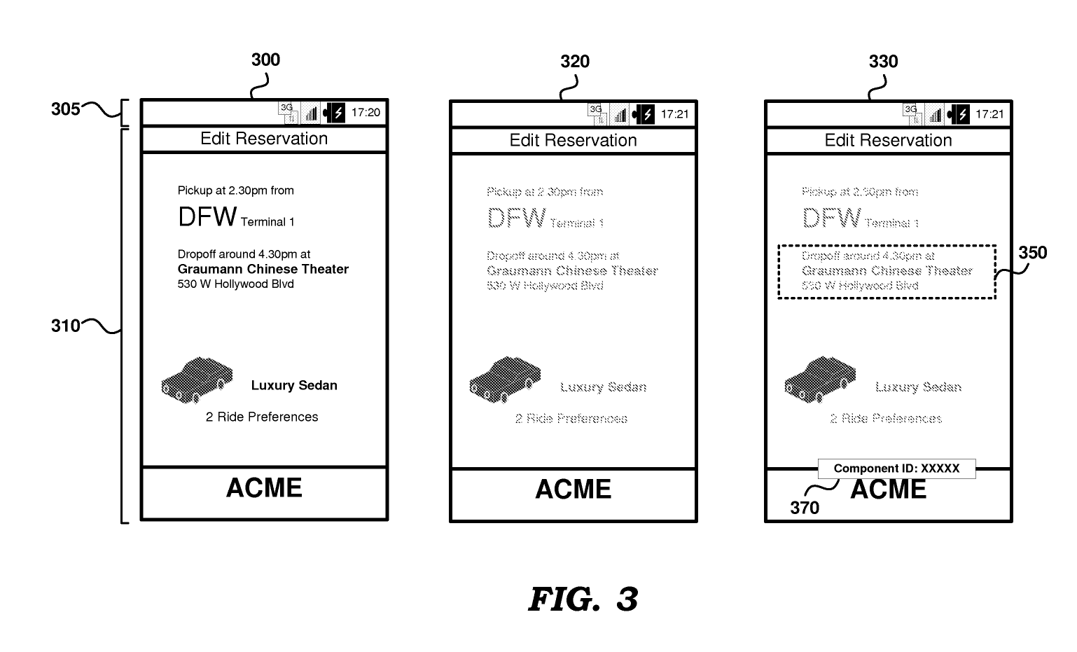

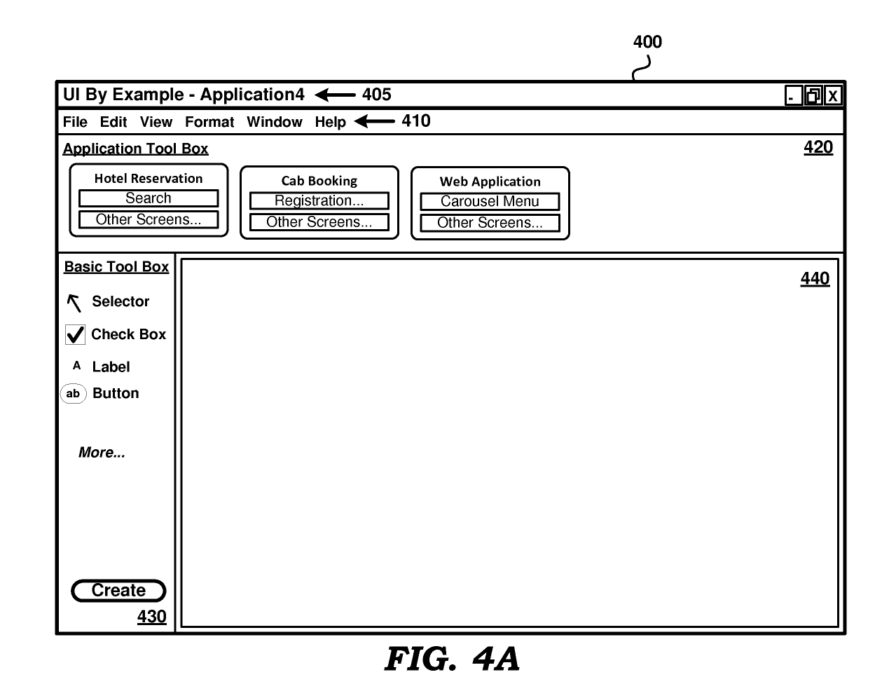

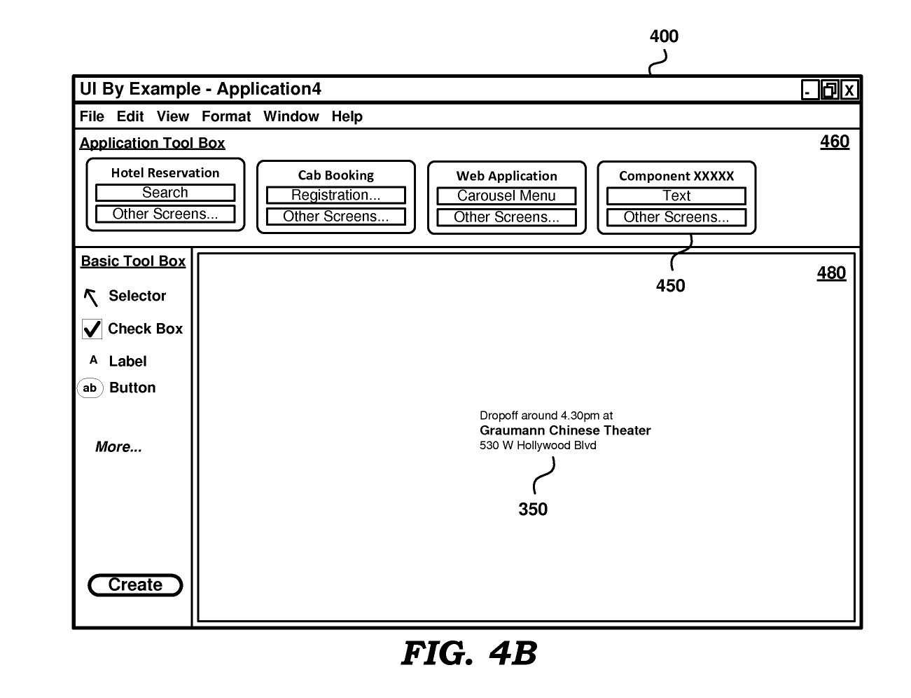

FIGS. 3 and 4A-4B together illustrate the manner in which a component of a currently displayed user interface is exported to a development system in one embodiment. For illustration, the exporting of components provided by mobile applications is described in detail below. However, the features of the present invention may be implemented with respect to user interface of other types (such as desktop application, web application, etc.) as well, as will be apparent to one skilled in the relevant arts by reading the disclosure herein. Each of the Figures is described in detail below.

FIG. 3 depicts the manner in a user/developer is enabled select a desired component of a currently displayed user interface in one embodiment. Display area 300 depicts a portion of a user interface displayed on a display unit of a mobile device (such as a mobile phone, tablet, etc.). The mobile device may correspond to one of end user systems 160A-160X. Display area 305 is provided by an operating system of the mobile device and displays the status information (such as connectivity, signal strength, battery remaining) and current time. It is noted that in the following description, display area 305 does not form part of the user interfaces provided by the applications.

Display area 310 depicts a portion of a user interface provided by a cab booking application. In particular, display area 310 enables a user to edit the details of a cab booking. It may be appreciated that display area 310 is shown containing various user interface components such as the text, icons, etc. (which may be presented using different visual attributes such as color, font, etc.).

Display area 320 indicates that a user/developer has entered a selection mode, during which the user wishes to select a component for exporting. It may be observed the user interface of display area 320 is similar to that of display area 310, but with the components shown in a different color (gray) to indicate that the selection mode has been entered. The user/developer may enter the selection mode by selecting a pre-defined option (provided in the menu of the application or mobile device), by performing a pre-defined gesture on the display unit (in the scenario that the display unit is a touch screen) or by pressing a pre-configured set of keys in the mobile device.

Display area 330 indicates that the user has selected component 350 for exporting to the development system. It may be appreciated that the selection of the specific component may be performed in a known way, for example, by clicking/touching on the component sought to be selected. Alternatively, the different components that form part of the user interface and which can be selected may be shown highlighted, with the user clicking on the highlighted portion to select the corresponding component. In the present embodiment, a developer uses a multi-touch gesture (on the touch screen) to indicate a selection (as indicated by the dotted rectangle in 350) around the outside of the component that the developers want to export.

In an embodiment of the present disclosure, the user/developer is required to manually download the interface definition of the selected component. Accordingly, the identifier of the selected component is exposed (here, displayed) to the user as shown in display area 370. Display area 370 indicates that the unique identifier of the selected component 350 is “XXXXX” (with each X representing a digit/character). The user may thereafter download, using the exposed identifier, the interface definition of the selected component from the repository (120) to the development system.

Thus, a user is enabled to manually export a component (350) of a currently displayed user interface (310) to a development system (for example, end user system 160A). It may be desirable that such export be done automatically (that is, without any further manual intervention), for example to an application development environment (ADE) used by the user/developer. The manner in which management tool 150 exports selected components from a currently displayed user interface to an ADE is described below with examples.

### 5. Exporting to an Application Development Environment

FIG. 4A illustrates the manner in which an application development environment (ADE) is provided in a development system in one embodiment. Display area 400 depicts various portions of a user interface provided as part of an ADE by management tool 150 (in response to a user/developer indicating that a new application is sought to be created). Display area 400 may be displayed on a display unit (not shown in FIG. 1) associated with one of end user systems 160A-160X (for illustration, assumed to be end user system 160A).

Display area 405 indicates the name of the ADE as “UI By Example”, and the name of the new application (being created) as “Application4”. Display area 410 provides various menu options that may be used by a user/developer during the creation of the user interfaces for the new application “Application4”.

Display area 440 represents a “canvas” in which the developer may incorporate the desired user interface components for creating the new user interface of the new application. The canvas is shown empty indicating that the user has not incorporated any components.

Display area 420 (Application Tool Box) displays the currently available components selected from other user interfaces of other applications. A developer accordingly may construct a new user interface by selecting the desired UI elements or components and then placing the selected elements at corresponding locations of the new user interface (canvas 440).

Display area 430 (Basic Tool Box) displays various basic/complex pre-configured UI elements/components that can be added to the new user interface (by selecting the desired component and placing the selected component in canvas 440). It should be appreciated that such a basic tool box may be provided for making minor modifications to the new user interface, after the developer has selected and incorporated various components from multiple applications (using the application tool box shown in display area 420). The components may include basic UI elements such as buttons, text fields, labels, etc. and/or complex UI elements such as tabs, scroll bars, etc. as is well known in the arts.

According to an aspect of the present disclosure, in response to a user selecting a component in a currently displayed user interface (for example, display area 310 of FIG. 3), management tool 150 makes available the selected component as part of the ADE in the development system (160A) such that the user is enabled to incorporate the component into the new user interface (canvas 440).

FIG. 4B illustrates the manner in which a component of a currently displayed user interface is provided as part of an application development environment (of FIG. 4A) in one embodiment. In particular, display area 460 (Application Tool Box) is shown including an additional component 450. Component 450 is the selected component (350) that has been included as part of display area 400, in response to the user selecting the same component (350) in display area 330 of FIG. 3.

The user/developer may thereafter select (using a combination of keyboard and/or mouse) the component 450 from the Application Tool Box 460 and place component 450 in canvas 440. Display area 480 depicts the “canvas” updated with the selections made by the developer. In particular, display area 480 is shown containing the component included in selection 350 of display area 330 in FIG. 3. The developer may also change the display properties (such as the location, width, height, etc.) and other behavior associated with the selected components.

A developer may select and incorporate desired components from other user interfaces provided by different applications, and thereafter construct a new user interface using the selected UI elements. After the desired new user interface is constructed, the developer may click on “Create” button to create the new user interface for the new application “Application4”. In one embodiment, management tool 150 generates a specification for the new user interface by incorporating the interface definitions for the selected components. The interface definitions of the selected components may be downloaded from repository 120.

Thus, management tool 150 facilitates the export of a component of a currently displayed user interface to a development system (for example, to an ADE provided in the development system). The description is continued with respect to a sample implementation of management tool 150 and end user system 160A.

### 6. Sample Implementation

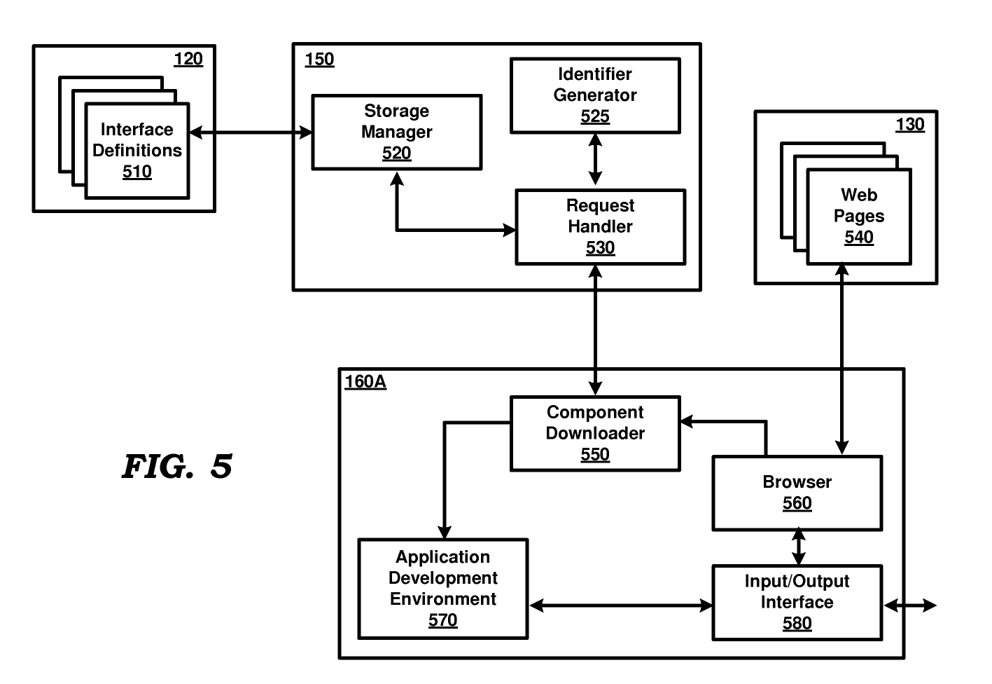

FIG. 5 illustrates the manner in which exporting of components of a currently displayed user interface to a development system is implemented in one embodiment. The block diagram is shown containing interface definitions 510, storage manager 520, identifier generator 525, request handler 530, web page 540, component downloader 550, browser 560, application development environment (ADE) 570, and input/output (IO) interface 580. Each block can be realized as corresponding executable module(s) executing on suitable hardware (e.g., processors described below). Each of the blocks is described in detail below.

Interface definitions 510, maintained in repository 120, specify the details of various UI components. In one embodiment, interface definitions 510 are specified as part of specification of user interfaces provided by multiple applications. The manner in which interface definitions (510) may be maintained in repository 120 is described in detail below.

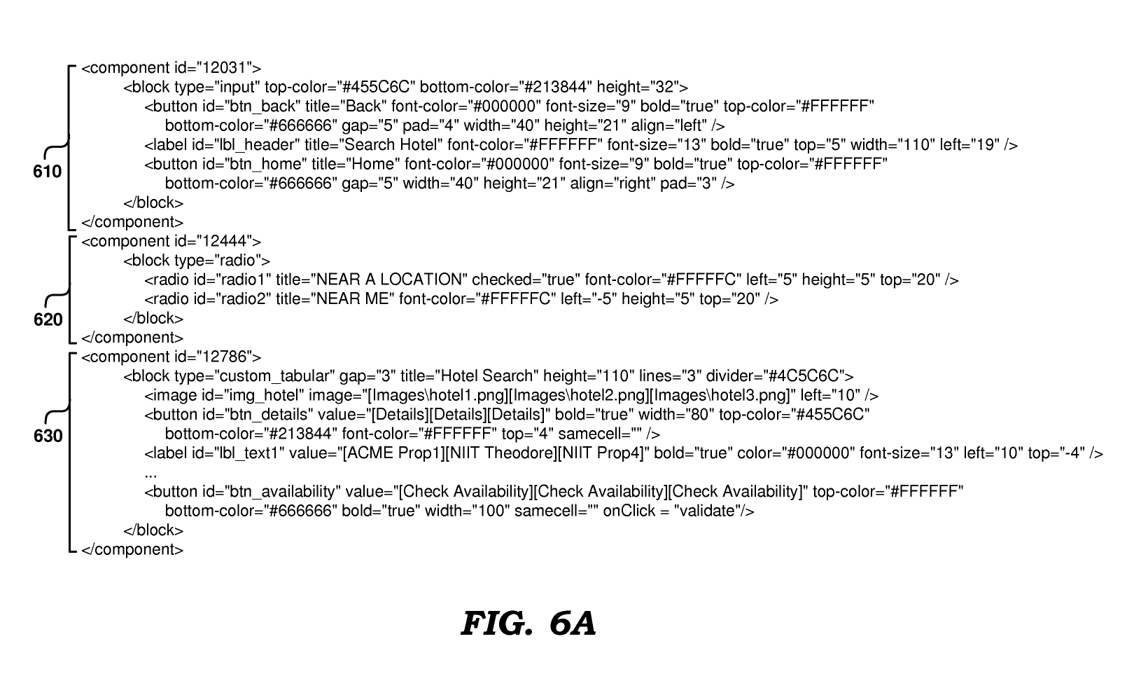

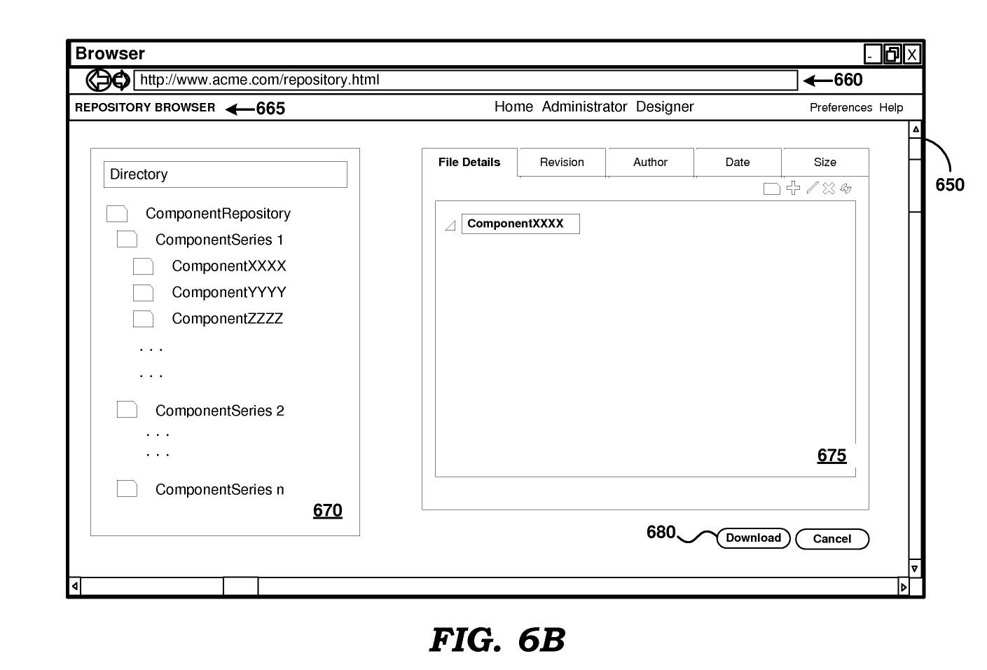

FIG. 6A illustrates the manner in which interface definitions of components are maintained in a repository in one embodiment. The specification is shown as being maintained according to extensible markup language (XML), for illustration. However, in alternative embodiments, the specifications may be maintained using other data formats such as HTML (hypertext markup language) and/or using other data structures (such as a table in a relational database), as will be apparent to one skilled in the relevant arts by reading the disclosure herein.

Each of data portions 610, 620 and 630 (between <component> and </component> tags) specifies the interface definitions of a corresponding component. It may be observed that each component tag is associated with a unique identifier such as “12031” (as indicated by the value of the “id” attribute). Thus, each of the components is uniquely identifiable by the associated identifier (generated by identifier generator 525, as described below).

It may be further observed that the interface definitions are shown containing the definitions of various UI elements (as indicated by the XML tags “<button>”, “<label>”, etc.). The definitions are shown specifying various display properties such as color, back-color, title, etc. of the UI element, and also the non-display (non-presentation) properties (such as id, type, etc.). The methods and events associated with each UI element may similarly be specified (for example, using other XML tags). Also, the button UI element having id “btn_availability” is shown invoking the method named “validate” (for validating the inputs provided by a user prior to submitting/sending the inputs). Other methods and events associated with each UI element may similarly be specified (for example, using other XML tags).

Thus, interface definitions 510 corresponding to various components are maintained in repository 120. The manner in which the interface definitions are created and accessed from repository 120 is described below with examples.

Referring again to FIG. 5, storage manager 520 is enabled to work with different formats of the interface definitions, and accordingly may perform any necessary conversions (XML to non-XML formats, or vice versa) during storing/retrieving of interface definitions 510 from repository 120. In one embodiment, storage manager 520 facilitates the conversion of interface definition according to various programming languages such as Java, C#, etc operative in different operating systems. Accordingly, a user/developer is facilitated to create a new user interface by incorporating the components from one or more heterogeneous systems (having different hardware and/or operating systems, and supporting different programming languages).

Identifier generator 530 generates unique identifiers for each component in the repository. The generation may be performed in any convenient manner, for example, similar to the generation of Globally Unique Identifier (GUID), as is well known in the arts. In general, the unique identifiers are not re-used, thereby ensuring that every component (previously present or currently added) is identifiable by the associated identifier.

Request handler 530 receives requests for components (by specifying their identifiers) from end user systems 160A-160X and in response sends the interface definitions of the requested components to the requesting end user system. In general, request handler 530 upon receiving a request containing an identifier of a component, interacts with (forwards the request/unique identifier to) storage manager 520, and receives the interface definition of the requested component from storage manager 520 (which in turn, retrieves the interface definition from repository 120 based on the identifier in the request). Request handler 530 then sends the interface definition of the requested component to the requesting end user systems (160A-160X).

Request handler 530 also receives requests for adding new components to repository 120. In response to a request for adding a new component, request handler 530 first interfaces with identifier generator 525 to obtain a new unique identifier for the new component, stores (using the storage manager 520) the new component associated with the new unique identifier (as the value of the “id” attribute in the “<component> tag”) in repository 120 and then may forward the new identifier to the requesting system. The new identifier received as a result, is embedded by developers in the web pages.

Web pages 540 represent specification of user interfaces (for example, according to HTML or XML) that are currently hosted by server system 130. Some of web pages 540 may include components that are currently stored in the repository (120), and accordingly the identifiers of the included components are also embedded in the web pages.

Browser 560 represents an application executing in end user system 160A, which receives one or more of web pages 540 and then renders, using input/output (IO) interface 580, the web pages on a display unit (not shown) associated with end user system 160A. For example, browser 560 may render a web page (specified according to XML) to provide the user interface of display area 310 in FIG. 3.

In response to a user indicating a selection of a component (as received from IO interface 580) on the currently displayed user interface, browser 560 determines the identifier of the selected component by inspecting the specification of the web page. For example, in response to the user selecting component 350 in display area 330 of FIG. 3, browser 560 may inspect the XML web page corresponding to the user interface of display area 310, and accordingly determines the identifier “XXXXX” (with each X representing a digit/character) for selected component 350.

In one embodiment, browser 560 displays the determined identifier on the display unit (using IO interface 580). The identifier may be display overlaying the currently displayed user interface, as shown in display area 370 of FIG. 3. Alternatively, browser 560 may be configured to send an email containing the determined identifier to a pre-specified email address of the user/developer.

Component downloader 550 facilitates the transfer of the interface definition of the selected component from repository 120 to the development system (160A). For example, component downloader 550 may be used by a user/downloader to download the interface definition of the selected component manually. In one embodiment, component downloader 550 also enables the user/developer to browse components maintained in repository 120 and to download interface definitions of components as described below with examples.

### 7. Transferring Interface Definitions

FIG. 6B illustrates an example implementation of a repository browser which enables users/developers to browse the various components present in the repository. Display area 650 (similar to display area 400) depicts a portion of a user interface provided on a display unit (not shown in FIG. 1) associated with one of end user systems 160A-160X. In one embodiment, display area 650 corresponds to a webpage accessed by the users using a browser in response to sending a request (including an identifier of the webpage, as indicated by the text in display area 660 for the web page “REPOSITORY BROWSER” as shown in display area 665) from end user system 160A to management tool 150.

Display area 670 displays a directory of all the components available in the repository. The components are shown grouped together as series, which in turn are shown organized in the form a tree/hierarchy. Display are 675 facilitates the user to view the details such as the file details, revision, author, date and size of a component selected in display area 670. The user/developer may then select the desired component and click on “Download” button 680 to download the interface definition of the selected component.

Thus, a user/developer may first get the identifier (XXXXX) for a desired component of currently displayed user interface, then browse to the component matching the identifier using the tree/hierarchy of display area 670 and details of display area 675, and then download (using button 680) the component for incorporating in a new user interface in the development system.

In another embodiment, browser 560 forwards automatically (that is, without further manual intervention) the identifier to component downloader 550, which in turn, interfaces (sends requests and receives responses) with request handler 530 to download the interface definition of the selected component (similar to data portions 610, 620 and 630). In one embodiment, component downloader 550 is implemented as a plug-in of browser 560, as is well known in the relevant arts.

Component downloader 550 then forwards the downloaded interface definition to application development environment (ADE) 570, which in turn displays the corresponding selected component as part of the user interface. For example, in response to the user selecting component 350 in display area 330 of FIG. 3, component downloader 550 downloads and forwards the interface definition of component 350, and accordingly causes ADE 570 to show the selected component 450 in display area 460 of FIG. 4B. In other words, prior to receiving a selected component, ADE 570 provides (using IO interface 580) a user interface similar to FIG. 4A, and after receiving the selected component, provides a user interface similar to FIG. 4B. In response to the user/developer placing the component 350 in display area 480 of FIG. 4B, the interface definition of the component (similar to data portions 610, 620 and 630) is included in the specification of the new user interface.

Thus, a user/developer is facilitated to identify the specific components of interest in a currently displayed user interface provided on an end user system and export the components of interest to a development system for developing new user interfaces.

Though the features of the present disclosure have been described above with respect to a single end user system (160A) as providing both the currently displayed user interface and the application development environment, it may be appreciated that in alternative embodiment, the features of the present disclosure may be implemented with the user interface of FIG. 3 being displayed in one end user system, while the user interface of FIGS. 4A-4B is provided in another end user system.

It may thus be appreciated that the components rendered in a browser can be conveniently exported to an application development environment, thereby simplifying the creation of new user interfaces.

It should be further appreciated that the features described above can be implemented in various embodiments as a desired combination of one or more of hardware, executable modules, and firmware. The description is continued with respect to an embodiment in which various features are operative when executable modules are executed.

### 8. Digital Processing System

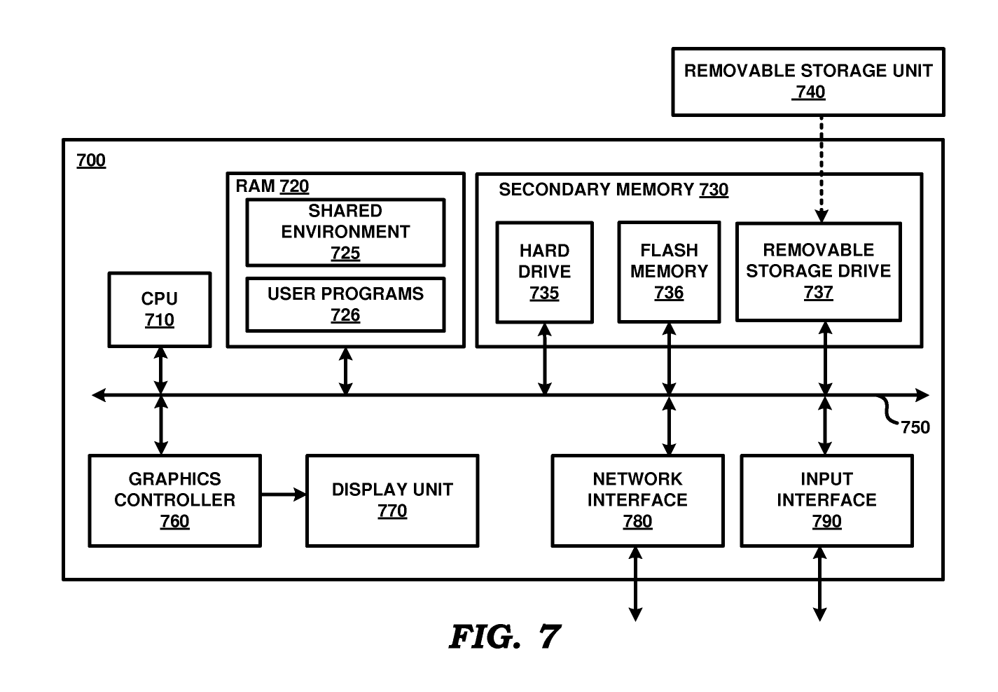

FIG. 7 is a block diagram illustrating the details of digital processing system 700 in which various aspects of the present disclosure are operative by execution of appropriate executable modules. Digital processing system 700 may correspond to management tool 150 and end user systems 160A-160X.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Each of the displays shown in FIGS. 3, 4A, 4B and 6B corresponds to an image screen displayed at corresponding time duration on the display screen. Input interface 790 may correspond to a keyboard and a pointing device (e.g., touch-pad, mouse) and may be used to provide inputs (such as those provided by users/developers using the user interfaces of FIGS. 3, 4A, 4B and 6B). Network interface 780 provides connectivity to a network (e.g., using Internet Protocol), and may be used to communicate with other systems (of FIG. 1) connected to the network (110).

Secondary memory 730 may contain hard drive 735, flash memory 736, and removable storage drive 737. Secondary memory 730 may store the data (for example, data of FIG. 6A, the specifications of the user interfaces, etc.) and software instructions (for implementing the flowchart of FIG. 2), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of simplifying development of user interfaces, said method comprising:
maintaining a repository of a plurality of components, with each component having an associated interface definition;
providing a user interface containing a set of components rendered on a display unit, said set of components being contained in said plurality of components;
receiving, from a user, a selection of a first component rendered on said display unit, said first component being contained in said set of components; and
in response to receiving of said selecting, making available the interface definition of said first component in defining a new user interface in a development system.

2. The method of claim 1, wherein each component of said plurality of components is assigned a corresponding identifier, said method further comprising:
embedding the corresponding identifiers of said set of components in a specification of said user interface; and
sending said specification to an end user system containing said display unit, wherein said end user system renders said specification to provide said user interface on said display unit,
wherein said making available comprises:
identifying a first identifier of said first component by examining said specification; and
transferring using said first identifier, the interface definition of said first component from said repository to said development system.

3. The method of claim 2, wherein said making available further comprises:
exposing said first identifier to said user;
receiving, in said development system, an input from said user based on said exposed first identifier, to download said first component; and
downloading, by said user using said first identifier, the interface definition of said first component from said repository to said development system, in response to said receiving of said input from said user.

4. The method of claim 2, wherein said new user interface is being developed using an application development environment in said development system,
wherein said making available further comprises providing said first component as part of said application development environment in said development system such that said user is enabled to incorporate said first component into said new user interface.

5. The method of claim 4, wherein said identifying, said transferring and said providing are performed automatically in response to said selecting.

6. The method of claim 1, wherein user interface is rendered by a browser in said development system, wherein said user is facilitated to export the interface definition of said first component from said browser to an application development environment in said development system.

7. A non-transitory machine readable medium storing one or more sequences of instructions for enabling a system to simplify development of user interfaces, wherein execution of said one or more instructions by one or more processors contained in said system enables said system to perform the actions of:
maintaining a repository of a plurality of components, with each component having an associated interface definition;
providing a user interface containing a set of components rendered on a display unit, said set of components being contained in said plurality of components;
receiving, from a user, a selection of a first component rendered on said display unit, said first component being contained in said set of components; and
in response to receiving of said selecting, making available the interface definition of said first component in defining a new user interface in a development system.

8. The machine readable medium of claim 7, wherein each component of said plurality of components is assigned a corresponding identifier, further comprising one or more instructions for:
embedding the corresponding identifiers of said set of components in a specification of said user interface; and
sending said specification to an end user system containing said display unit, wherein said end user system renders said specification to provide said user interface on said display unit,
wherein said making available comprises one or more instructions for:
identifying a first identifier of said first component by examining said specification; and
transferring using said first identifier, the interface definition of said first component from said repository to said development system.

9. The machine readable medium of claim 8, wherein said making available further comprises one or more instructions for:
exposing said first identifier to said user;
receiving, in said development system, an input from said user based on said exposed first identifier, to download said first component; and
downloading, by said user using said first identifier, the interface definition of said first component from said repository to said development system, in response to said receiving of said input from said user.

10. The machine readable medium of claim 8, wherein said new user interface is being developed using an application development environment in said development system,
wherein said making available further comprises one or more instructions for providing said first component as part of said application development environment in said development system such that said user is enabled to incorporate said first component into said new user interface.

11. The machine readable medium of claim 10, wherein said identifying, said transferring and said providing are performed automatically in response to said selecting.

12. A digital processing system comprising:
a processor;
a random access memory (RAM);
a machine readable medium to store one or more instructions, which when retrieved into said RAM and executed by said processor causes said digital processing system to simplify development of user interfaces, said digital processing system performing the actions of:
maintaining a repository of a plurality of components, with each component having an associated interface definition;
providing a user interface containing a set of components rendered on a display unit, said set of components being contained in said plurality of components;
receiving, from a user, a selection of a first component rendered on said display unit, said first component being contained in said set of components; and
in response to receiving of said selecting, making available the interface definition of said first component in defining a new user interface in a development system.

13. The digital processing system of claim 12, wherein each component of said plurality of components is assigned a corresponding identifier, wherein said digital processing system further performs the actions of:
embedding the corresponding identifiers of said set of components in a specification of said user interface; and
sending said specification to an end user system containing said display unit, wherein said end user system renders said specification to provide said user interface on said display unit,
wherein for said making available, said digital processing system performs the actions of:
identifying a first identifier of said first component by examining said specification; and
transferring using said first identifier, the interface definition of said first component from said repository to said development system.

14. The digital processing system of claim 13, wherein for said making available, said digital processing system further performs the actions of:
exposing said first identifier to said user;
receiving, in said development system, an input from said user based on said exposed first identifier, to download said first component; and
downloading, by said user using said first identifier, the interface definition of said first component from said repository to said development system, in response to said receiving of said input from said user.

15. The digital processing system of claim 13, wherein said new user interface is being developed using an application development environment in said development system,
wherein for said making available, said digital processing system further performs the actions of providing said first component as part of said application development environment in said development system such that said user is enabled to incorporate said first component into said new user interface.

16. The digital processing system of claim 15, wherein said digital processing system performs the actions of said identifying, said transferring and said providing automatically in response to said selecting.
